(19) United States
(12) Patent Application Publication
(10) Pub. No.: US 2021/0116000 A1
(43) Pub. Date: Apr. 22, 2021

(54) DAMPING DEVICE FOR A POWERTRAIN OF A MOTOR VEHICLE, IN PARTICULAR A CAR, AND POWERTRAIN COMPRISING SUCH A DAMPING DEVICE

(71) Applicant: AUDI AG, Ingolstadt (DE)

(72) Inventor: Thomas OBERHAUSER, Ingolstadt (DE)

(73) Assignee: AUDI AG, Ingolstadt (DE)

(21) Appl. No.: 16/495,186

(22) PCT Filed: Mar. 20, 2018
(86) PCT No.: PCT/EP2018/056947

§ 371 Date: Sep. 18, 2019

(30) Foreign Application Priority Data
Mar. 30, 2017 (DE) 10 2017 205 399.2

(51) Int. Cl. F16F 15/16; F16D 3/80; B60K 17/22

(52) U.S. Cl. CPC F16F 15/161; F16D 3/80; F16F 2222/12; F16F 2228/066; B60K 17/22

(57) ABSTRACT

A damping apparatus for a drivetrain of a motor vehicle, with a first damping element which is rotatable about an axis of rotation, a second damping element which can be driven by the first damping element and is thereby rotatable about the axis of rotation, at least two damping chambers, the volumes of which can be modified by a relative rotation between the damping elements, at least one overflow channel, by which the damping chambers are connected to one another fluidly, and having a damping fluid, which flows from one damping chamber into the other damping chamber via the overflow channel upon a volume reduction of one of the damping chambers. The overflow channel flowing into the respective damping chambers at both ends is formed by a gap between the damping elements, the gap being directly limited by the damping elements, at least in a lengthwise region.

The invention relates to a damping apparatus for a drivetrain of a vehicle, particularly of a motor vehicle, according to the respective preamble of claim 1 and/or 12. In addition, the invention relates to a drivetrain for a vehicle having at least one such damping apparatus.

A damping apparatus for a drivetrain of a vehicle, particularly of a motor vehicle such as, for example, of a passenger car, is already known, for example, from DE 10 2007 003 061 A1. The damping apparatus in this case has a first damping element, which is rotatable about an axis of rotation, and a second damping element, which can be driven by the first damping element and is thereby rotatable about the axis of rotation. In the completely manufactured state of the drivetrain, the first damping element, for example, is connected to a first shaft in a torsionally resistant manner or can be driven by the first shaft, wherein the second damping element, for example, is connected to a second shaft of the drivetrain in a torsionally resistant manner or the second shaft can be driven by the second damping element. For example, if the first damping element is driven by the first shaft, the second damping element can thus then be driven by the first damping element. Consequently, the second shaft, for example, is driven by the second damping element such that, as a whole, the second shaft is driven by means of the damping apparatus and thus by means of the damping elements of the first shaft. As an alternative or in addition to this, it is conversely conceivable that the first shaft can be driven by the second shaft by means of the damping apparatus. Thus, torques are transferable between the shafts, for example, by means of the damping apparatuses.

The damping apparatus further comprises at least two damping chambers, the volumes of which can be modified by means of a relative rotation between the damping elements. In other words, if a relative rotation, for example, results between the damping elements, this results in a volume decrease of a first of the damping chambers and a volume increase of the second damping chamber. In particular, the volume of the first damping chamber, for example, is increased by an amount that the volume of the second damping chamber is decreased or vice versa.

The damping apparatus further has at least one overflow channel, by means of which the damping chambers are fluidly connected to one another. In addition, a damping fluid is provided, which flows from the one damping chamber into the other damping chamber by means of the overflow channel upon a reduction in volume of one of the damping chambers. Due to the volume reduction of the one damping chamber, at least one part of the damping fluid initially being held in the one damping chamber, for example, is displaced from the one damping chamber such that at least the displaced portion flows through the overflow channel and thus flows out of the one damping chamber and into the other damping chamber by means of the overflow channel.

Such a damping apparatus is known, for example, from U.S. Pat. No. 6,769,520 B2. In addition, DE 29 30 244 C2 discloses a torsionally flexible coupling to connect two shafts arranged substantially flush with one another, consisting of a metallic, star-shaped inner coupling half provided with dog attachments extending radially outward, a sleeve-shaped, metallic outer coupling half spaced apart from and surrounding said inner coupling half concentrically, and a rubber spring element retained between the coupling halves, with volume-changeable chambers, which are connected to one another, being recessed in said rubber spring element by means of one or more overflow channels forming a throttle point, filled particularly hydraulically with a damping means.

Moreover, DE 31 42 023 C1 discloses a torsionally flexible, hydraulically damping coupling, consisting of two flanges spaced apart from one another, which can be attached to shafts, each flange having at least three dogs engaging one another, a rubber element surrounding the dogs with force and positive locking having chambers formed between the dogs and filled with damping fluid, as well as throttle openings incorporated into the dogs of at least one flange, by means of said throttle openings the chambers located on both sides of this dog are retained together in a fluid connection.

The object of the present invention is to further develop a damping apparatus and a drivetrain of the aforementioned type such that contact and/or edge changes can be damped in an especially advantageous and simple manner.

Said object is achieved by means of a damping apparatus with the features of claim 1, a damping apparatus with the features of claim 12, as well as by a drivetrain with the features of claim 14. Advantageous embodiments with suitable further embodiments of the invention are indicated in the remaining claims.

A first aspect of the invention relates to a damping apparatus for a drivetrain of a vehicle, particularly a motor vehicle such as, for example, a passenger car. The damping apparatus has a first damping element, which is rotatable about an axis of rotation, and a second damping element, which is rotatable about the axis of rotation, which can be driven by the first damping element and is thereby rotatable about the axis of rotation. Furthermore, the damping apparatus has at least two damping chambers, the volumes of which can be modified by means of a relative rotation between the damping elements. For example, if there is a relative rotation between the damping elements, the volume of a first of the damping chambers is increased, for example, while the volume of the second damping chamber is reduced. In particular, the volume of the first damping chamber is increased by an amount that the volume of the second damping chamber is decreased or vice versa.

The damping apparatus further has at least one overflow channel, by means of which the damping chambers are fluidly connected to one another or can be connected. In addition, a damping fluid, for example formed as a gas or fluid, is provided, which flows from the one damping chamber into the other damping chamber by means of the overflow channel upon a reduction in volume of one of the damping chambers. For example, if there is such a relative rotation between the damping elements that there is a volume reduction of the one damping chamber and thus a volume increase of the other damping chamber, wherein the one damping chamber, for example, is reduced in volume by the amount that the other damping chamber is increased in volume, at least one portion of the damping fluid initially being held in the one damping chamber, for example, is displaced from the one damping chamber. Consequently, at least the displaced portion of the damping fluid, for example, flows through the overflow channel into the other damping chamber such that at least the displaced portion of the damping fluid flows out of the one damping chamber and into the other damping chamber by means of the overflow channel.

Due to the damping apparatus, particularly due to the rotational capacity of the damping elements relative to one another, the damping apparatus, for example, can accommodate and/or compensate for play in the drivetrain, which is also characterized as drivetrain play. In the completely manufactured state of the drivetrain, the first damping element, for example, is connected to a first shaft element in a torsionally resistant manner or can be driven by the first shaft element in that, for example, the torques are transferred from the first shaft element to the first damping element. Furthermore, the second damping element, for example, is connected to a second shaft element of the drivetrain in a torsionally resistant manner or the second shaft element can be driven by the second damping element. For example, if the first damping element is thus driven by the first shaft element, the second damping element, for example, is then driven by the first damping element, and the second shaft element is driven by the second damping element. As a whole, thus the second shaft element is driven by the first shaft element by means of the damping apparatus and thus by means of the damping elements such that, for example, torques are transferred from the first shaft element to the second shaft element by means of the damping apparatus. As an alternative or in addition to this, the reverse is conceivable such that, for example, the first shaft can be driven by the second element by means of the damping apparatus. As a whole it is discernible that, for example, torques can be transferred between the shaft elements by means of the damping apparatus.

For example, the shaft elements or the damping elements can be rotated about the axis of rotation in a first direction of rotation. As an alternative or in addition to this, it is conceivable that the shaft elements or the damping elements can be rotated about the axis of rotation in a second direction of rotation opposite the first direction of rotation. Due to relative rotations between the damping elements, contact or edge changes may result. Because an at least partial displacement of the damping fluid, particularly from the one of the damping chambers that is reduced in volume, results in the described manner due to the relative rotations between the damping elements, the contact or edge changes are damped, because the overflow channel, for example, acts as a throttle for the damping fluid flowing through the overflow channel and formed, for example, as hydraulic fluid. The damping apparatus, for example, is an at least two-part component, which comprises at least the damping elements as structural elements of the damping apparatus. For example, the damping apparatus is arranged, based on a torque flow, before or after a drivetrain universal shaft formed as a cardan shaft. Undesirable noises in the drivetrain can be prevented by damping the contact or edge changes.

In order to then damp the contact or edge changes especially advantageously and in an especially simple and thus economical manner, it is provided according to the invention that the overflow channel flowing into the respective damping chambers at both ends is formed by a gap between the damping elements, said gap being directly limited by the damping elements, at least in a lengthwise region. This means, for example, that a first portion or a first partial region of the gap is directly limited by the first damping element and a second portion or a second partial region of the gap is directly limited by the second damping element. The direct limiting of the gap by the respective damping element should be understood to mean, for example, that no further structural element of the damping apparatus is arranged between the gap and the respective damping element and/or that the damping fluid flowing through the gap flows directly to and makes contact with or can flow to and can make contact with the damping elements or respective wall regions of the damping elements, said wall regions directly limiting the gap.

The invention is based in this case particularly on the knowledge that the overflow channel is formed conventionally by means of a passage opening, which is specially produced and formed, for example, as a borehole, said passage opening typically being formed precisely in one of the damping elements. An additional, time-consuming and cost-intensive processing of that one of the damping elements, through which the overflow channel extends, is thereby necessary in order to produce the overflow channel. Such time-consuming and costly additional processing can then be avoided with the damping apparatus according to the invention, because the overflow channel is limited, particularly at least partially, at least predominantly, or completely, by the damping elements already being provided. With relative rotations between the damping elements, the damping fluid, for example, can flow back and forth between the damping chambers via the gap, whereby a damping of contact or edge changes can be implemented in an especially advantageous manner and particularly on both sides.

In order to keep the costs of the damping apparatus particularly low, it is provided in a further embodiment of the invention that the overflow channel is formed, at least predominantly, particularly completely, by the gap. The at least predominant formation of the overflow channel by the gap should be understood to mean that more than half of the extension of the overflow channel is formed by the gap.

In a further embodiment of the invention, the width of the gap can be adjusted in order to adjust the damping effect of the damping apparatus. The width of the gap is also characterized as the gap width, wherein the damping effect of the damping apparatus can be adjusted by adjusting the gap width. An especially advantageous and particularly need-based damping can hereby be implemented. In particular, the damping can be thusly adapted to different operating states.

In order to adjust the gap width and thus the damping effect especially simply and economically, at least one adjusting element, which can be moved relative to at least one of the damping elements, particularly relative to both damping elements, and which directly limits at least a portion of the gap, by means of said adjusting element the width of the gap can be adjusted, is provided with a further embodiment of the invention.

In order to keep the costs especially low in this case, the adjusting element, which is movable relative to the at least one damping element, is a component of the other damping element. In doing so, it has proven to be especially advantageous when the adjusting element is retained in a movable manner on a corresponding structural element of the other damping element. Thus, the other damping element, for example, is formed in at least two parts and comprises the adjusting element and the corresponding structural element, on which the adjusting element can be moved, particularly can be moved in a rotary and/or translational manner. For example, if the adjusting element is thus moved relative to the corresponding structural element of the other damping element, the gap width is thereby modified and thus adjusted.

In order to adjust the gap width especially simply and economically as well as on a need basis, it is provided in a further embodiment of the invention that the width of the gap is adjustable by means of at least one thread.

In doing so, it has proven to be especially advantageous when the adjusting element has the aforementioned thread, which is formed, for example, as an outer thread. The adjusting element in this case is retained on the structural element in a movable manner via the thread and via a corresponding further thread provided on the structural element, which is formed, for example, as an inner thread. By means of the interlocking threads, a rotary motion of the adjusting element relative to the structural element can be converted into a translational motion of the adjusting element relative to the structural element, wherein the gap width, for example, is modified by means of the translational motion of the adjusting element relative to the structural element and can thereby be adjusted. In this manner, the gap width can be adjusted especially precisely and simply.

In order to keep the number of parts and thus the costs, the weight, and the installation space of the damping apparatus especially low, it is provided in a further embodiment of the invention that the damping elements directly limit the damping chambers. As previously explained with respect to the gap, the direct limiting of the damping chambers should be understood to mean, for example, that the damping fluid held, for example, in the respective damping chamber can directly flow to and make contact with the damping elements or respective wall regions of the damping elements, said wall elements directly limiting the respective damping chambers.

For example, the damping elements are formed from a metallic material. In particular, it is conceivable that the damping elements are formed from a plastic and, in this case, preferably from a fiber-reinforced plastic. A further embodiment is characterized in that at least one wall region, particularly at least one of the damping elements, which limits, particularly directly, at least one of the damping chambers, has a bow-shaped profile. An especially advantageous damping effect can thereby be implemented in a simple and economical manner.

In doing so, it has proven to be especially advantageous when the bow-shaped profile extends over the complete radial extension of the at least one damping chamber, whereby an especially advantageous damping effect can be implemented in an economical manner.

A second aspect of the invention relates to a damping apparatus for a drivetrain of a vehicle, particularly a motor vehicle such as, for example, a passenger car. The damping apparatus according to the second aspect of the invention has a first damping element, which is rotatable about an axis of rotation, and a second damping element, which is rotatable about the axis of rotation, said damping element being driven by the first damping element. In this case, the previous statements regarding the first aspect of the invention, particularly the advantages and advantageous embodiments of the first aspect of the invention, can be transferred to the second aspect of the invention and vice versa.

In order to implement an especially advantageous damping within the scope of the second aspect of the invention in an especially economical manner, it is provided according to the invention that the damping elements according to the second aspect of the invention have respective threads, which are screwed together and thus interlocking, by means of which a relative rotation between the damping elements can be converted into a rotary relative motion between the damping elements.

In addition, according to the invention, it is provided with the second aspect of the invention that at least one damping part, formed from an elastically deformable material, particularly rubber, is arranged on at least one of the damping elements, the other respective damping element being movable in supportive contact with said damping element due to the translational relative motion.

In other words, if initially the one damping element, for example, is rotated, in that the one damping element, for example, is driven, this results, for example, in a relative rotation between the damping elements. By means of the threads, this relative rotation between the damping elements is converted into a translational relative motion between the damping elements such that, for example, the other damping element is moved translationally in the direction of the damping part, particularly along the axis of rotation, and finally comes to rest in supportive contact with the damping part. As a result, the damping part is elastically deformed by means of the other damping element, whereby motion energy of the damping elements, for example, is converted into deformation energy. An especially advantageous damping of contact or edge changes can hereby be implemented in an especially simple manner. For example, if the other damping element is then again moved away from the damping part, particularly translationally and/or along the axis of rotation, the damping part, for example, can spring back elastically for example. This damping takes place, for example, in a first direction along the axis of rotation or, when there is a relative rotation between the damping elements, in a first direction of rotation about the axis of rotation.

In doing so, in order to also then thusly implement an especially advantageous damping in a second direction opposite the first direction when there is a relative rotation between the damping elements in a second direction of rotation opposite the first direction of rotation, it is provided in an advantageous embodiment of the invention that a further damping part, made of an elastically deformable material, which is opposite the damping part, is provided on at least one of the damping elements, the other respective damping element being movable in supportive contact with said damping element due to the translational relative motion.

The elastically deformable material, for example, is an elastomer or a rubber, whereby especially advantageous damping properties can be realized.

A third aspect of the invention relates to a drivetrain for a vehicle, particularly for a motor vehicle such as, for example, a passenger car. The drivetrain according to the invention in this case has an inventive damping apparatus according to the first aspect and/or the second aspect of the invention. Advantages and advantageous embodiments of the first aspect of the invention and of the second aspect of the invention in this case should be considered advantages and advantageous embodiments of the third aspect of the invention and vice versa.

Further advantages, features, and details of the invention result from the following description of the preferred exemplary embodiments, as well as the drawing: The features and feature combinations listed previously in the description as well as the features and feature combinations listed in the figure description and/or in the single figure alone in the following can be used not only in the respectively indicated combination, but also in other combinations, or in isolation, without going beyond the scope of the invention.

The following is shown:

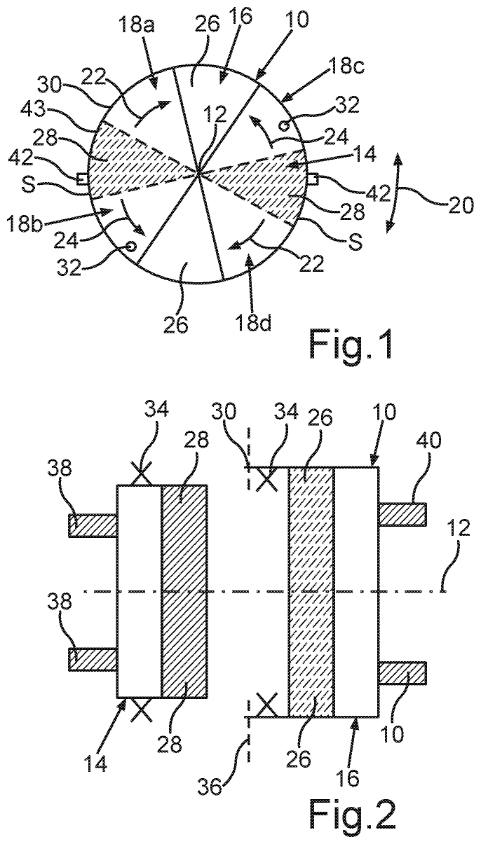

FIG. 1 sectionally shows a schematic cross-sectional view of a damping apparatus according to a first embodiment for a drivetrain of a motor vehicle, having at least two damping elements, which are rotatable relative to one another, and having at least one overflow channel, which is formed, at least in a lengthwise region, by a gap between the damping elements directly limited by the damping elements;

FIG. 2 sectionally shows a schematic and partially sectional side view of the damping apparatus according to FIG. 1 in an exploded view;

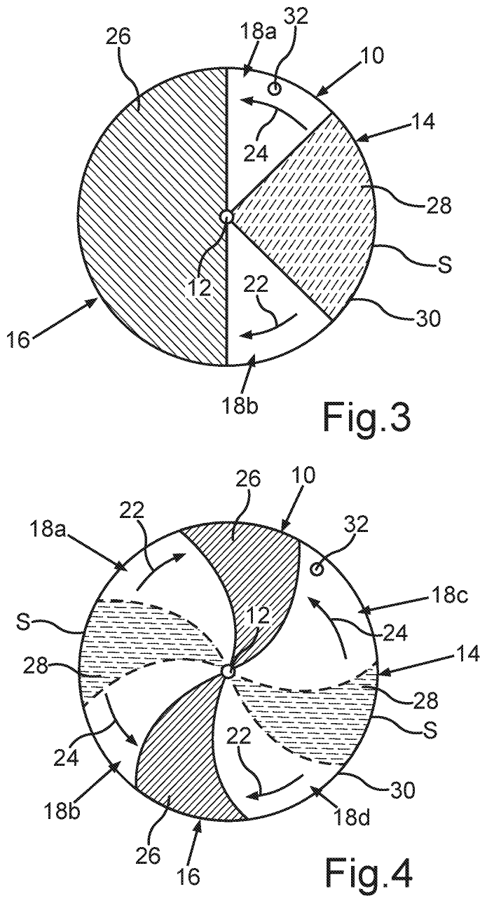

FIG. 3 sectionally shows a schematic cross-sectional view of the damping apparatus according to a second embodiment;

FIG. 4 sectionally shows a schematic cross-sectional view of the damping apparatus according to a third embodiment; and

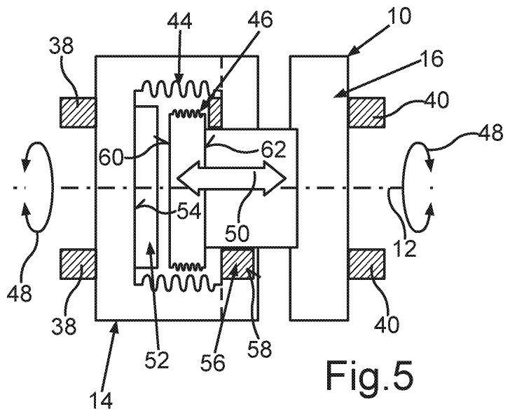

FIG. 5 sectionally shows a schematic and partially sectional side view of the damping apparatus according to a fourth embodiment.

Similar or functionally equivalent elements have the same reference numbers in the figures.

FIG. 1 sectionally shows, in a schematic cross-sectional view, a first embodiment of a damping apparatus, characterized as a whole with 10, for a drivetrain of a vehicle, particularly a motor vehicle such as, for example, a passenger car. The damping apparatus 10 according to the first embodiment is shown in a schematic and partially sectional side view in FIG. 2. In the completely manufactured state, the motor vehicle comprises the aforementioned drivetrain, by means of which the motor vehicle can be driven. To this end, the drivetrain comprises, for example, at least one drive motor, which may be formed as an internal combustion engine or electric motor. The drive motor has at least one output shaft formed, for example, as a crankshaft, by means of which the drive motor can provide torques for driving the motor vehicle.

The drivetrain further comprises a universal shaft formed as a cardan shaft, by means of which, for example, the torques provided by the drive motor can be transferred to at least one axle of the drivetrain. Thus, the cardan shaft can be driven, for example, by the output shaft or by the torques provided by the drive motor via the output shaft. In relation to a torque flow from the drive motor to the axle, at least one further drive element is provided, for example, after or downstream of the cardan shaft, with it being possible to transfer the torques from the cardan shaft to said drive element, so that, for example, the drive element can be driven by the cardan shaft. The cardan shaft is, for example, a shaft of the drivetrain. The damping apparatus 10 is arranged, for example, before or after the cardan shaft such that the damping apparatus 10 is arranged between the output shaft and the cardan shaft or between the cardan shaft and the drive element, for example in relation to the torque flow. Thus, the cardan shaft can be driven, for example, by the output shaft via the damping apparatus 10, or the drive element can be driven by the cardan shaft via the damping apparatus 10. Thus, the aforementioned torques between the cardan shaft and the output shaft or between the cardan shaft and the drive element can be transferred via the damping apparatus 10. The drive element, for example, is a further shaft or a further shaft element of the drivetrain.

As is shown especially well in FIG. 2, the damping apparatus 10 comprises a first damping element 14, which is rotatable about an axis of rotation 12, and a second damping element 16, which is rotatable about the axis of rotation 12, which can be driven by the first damping element 14 and is thereby rotatable about the axis of rotation 12. In particular, damping elements 14 and 16 are arranged coaxially with respect to one another, particularly in relation to the axis of rotation 12. For example, the aforementioned torques can be transferred to damping element 16 via damping element 14.

When viewed together with FIG. 1, it can be seen that the damping apparatus 10 has a plurality of damping chambers 18a-d, wherein damping chambers 18a, b, for example, form a first pair of chambers and damping chambers 18c, d form a second pair of chambers. In doing so, the respective damping chamber 18a-d, the respective volume of which can be modified by a relative rotation between damping elements 14 and 16, is arranged between respective damping elements 14 and 16 in the circumferential direction of the damping apparatus 10. In this case, the circumferential direction in FIG. 1 is indicated by a double arrow 20, wherein the circumferential direction extends about the axis of rotation 12. For example, if damping element 14 is rotated relative to damping element 16 in a first direction of rotation 12, indicated by arrow 22 in FIG. 1, this results in a volume reduction of damping chambers 18a, d and a volume increase in damping chambers 18b, c. In doing so, the respective volumes of damping chambers 18a, d are reduced by the same amount that the respective volumes of damping chambers 18b, c are increased.

For example, if damping element 14 is rotated relative to damping element 16 in a second direction of rotation 12, indicated by arrow 24 in FIG. 1, opposite the first direction of rotation, this results in a respective volume reduction of damping chambers 18b, c and in a respective volume increase in damping chambers 18a, d. In doing so, the respective volumes of damping chambers 18b, c are reduced by the same amount that the respective volumes of damping chambers 18a, d are increased.

FIG. 1 shows that damping chambers 18a-d are limited, particularly directly, by respective wall regions 26 and 28 of the damping apparatus 10, particularly in the circumferential direction of the damping apparatus 10. In doing so, wall regions 26 are formed by damping element 16, while wall regions 28 are formed by damping element 14. In the radial direction of the damping apparatus 10 outward, the damping chambers 18a-d are limited, for example, by a wall 30, which is formed, for example, by damping element 16, as particularly shown in FIG. 2. For example, at least one overflow channel, by means of which damping chambers 18a, b or 18c, d, particularly of the respective pair of chambers, are fluidly connected to one another, is provided per wall region 28 or per pair of chambers, respectively.

In addition, the damping apparatus 10 has a damping fluid 32, especially schematically shown in FIG. 1, which may be formed, for example, as a gas or as a fluid, particularly as a viscous fluid. For example, the damping fluid is formed as air. Furthermore, it is conceivable that the damping fluid is formed as hydraulic fluid such as, for example, a viscous oil.

For example, with such a relative rotation between damping elements 14 and 16, in which a volume reduction of damping elements 18a, d results, the damping fluid initially being held, for example, in damping chambers 18a, d can flow from respective damping chambers 18a, d into respective damping chambers 18b, c via the overflow channels. For example, because the respective overflow channel has a flow diameter that the damping fluid can flow through, which is substantially smaller than respective damping chambers 18a-d, the respective overflow channel, for example, functions as a throttle for the damping fluid such that the relative rotation between damping elements 14 and 16 is damped by means of the damping fluid.

The contact or edge changes can thereby be damped. If this accordingly results in such a relative rotation between damping elements 14 and 16, in which a volume reduction of damping elements 18b, c results, the damping fluid initially being held in damping chambers 18b, c flows from damping chambers 18b, c into respective damping chambers 18a, d via the overflow channels. In other words, due to a volume reduction in respective damping chamber 18a, d, at least a portion of the damping fluid being held initially in respective damping chamber 18a-d is displaced from respective damping chamber 18a, d such that the displaced portion flows from respective damping chamber 18a, d into the other respective damping chamber 18a-d of the respective pair of chambers, via the respective overflow channel. An excessively hard contact change can thereby be prevented such that the development of undesirable noises can be avoided.

In order to then implement an especially advantageous damping of the contact or edge changes in an especially simple and economical manner, the respective overflow channel flowing into respective damping chambers 18a, b or 18c, d, respectively, of the respective pair of chambers, at both ends is formed by a gap S between damping elements 14 and 16, said gap being directly limited by damping elements 14 and 16, at least in a lengthwise region, particularly at least predominately or completely. FIG. 1 shows that, with the first embodiment, the respective gap S is limited outward in the radial direction directly by wall region 30 and thus directly by damping element 16, wherein the respective gap S is limited inward in the radial direction directly by respective wall region 28 and thus by damping element 14. The direct limiting is understood to mean that the damping fluid flowing through the respective gap S, particularly in the circumferential direction of the damping apparatus 10, makes direct contact with respective wall region 28 or 30, respectively. Due to this damping of contact or edge changes, load changes, for example, can be damped such that an especially advantageous load change damping can be represented with the drivetrain.

In order to prevent leakages, for example, as well as undesirable flows of the damping fluid, sealing elements 34, for example, are provided, which are supported, for example, outward in the radial direction on damping element 16, particularly on wall region 30, and supported inward in the radial direction on damping element 14. Damping elements 14 and 16 are sealed off to one another by means of the sealing elements 34. For example, respective sealing element 34 is formed as a seal ring. In addition, at least one securing element is provided, which is formed as a circlip 36 with the first embodiment. By means of the circlip 36, damping elements 14 and 16 are secured relative to one another, for example, in the axial direction and thus along the axis of rotation 12 such that, for example, axial relative motions between damping elements 14 and 16 can be at least limited or prevented by means of the circlip 36.

In addition, damping element 14 has securing elements 38, by means of which, for example, damping element 14 can be coupled, particularly can be connected in a torsionally resistant manner, with the output shaft or with the cardan shaft. Moreover, damping element 16 has securing elements 40, by means of which damping element 16, for example, can be coupled, particularly can be connected in a torsionally resistant manner, with the cardan shaft or with the aforementioned drive element.

The gaps S, for example, have different geometries, particularly different widths. In other words, the gaps S, for example, differ from one another in their respective widths extending particularly in the radial direction of the damping apparatus 10, wherein the respective width of the respective gap is also characterized as the gap width.

For example, in order to adjust the damping effect of the damping apparatus 10 on a need basis, the respective gap S, for example, can be adjusted in its width particularly extending in the radial direction of the damping apparatus 10, wherein the width of the respective gap S is also characterized as the gap width.

To this end, at least one adjusting element 42, for example, which is moveable relative to at least one of damping elements 14 and 16, particularly in the radial direction of the damping apparatus 10, and directly limits at least one portion of the respective gap S, is provided, particularly per each gap S, it being possible to adjust the respective width of the respective gap S by means of said adjusting element. The respective adjusting element 42 is retained, for example, in a moveable manner on damping element 16, particularly on a corresponding structural element of damping element 16, and can be moved relative to damping element 14 and relative to damping element 16 or the structural element of damping element 16, particularly in the radial direction of the damping apparatus 10.

In particular due to the radial motion of the adjusting element 42 relative to damping element 14 and the corresponding structural element or damping element 16, the respective width of the respective gap S can be adjusted on a need basis. To this end, the adjusting element 42, for example, has a first thread in the form of an outer thread, wherein damping element 16, for example, or the structural element has a second thread, in the form of an inner thread, corresponding to the first thread. Via the thread, the respective adjusting element 42 is threaded with damping element 16 or with the corresponding structural element of damping element 16 such that the threads interlock. For example, if the adjusting element 42 is rotated about a further axis of rotation, extending, for example, at an angle or perpendicular to the axis of rotation 12, relative to damping element 14 and relative to the corresponding structural element of damping element 16, this relative rotation is converted, by means of the thread, into a translational motion of the adjusting element 42 relative to damping element 14 and the structural element, particularly along the further axis of rotation.

For example, if the respective adjusting element 42 is rotated such that the respective adjusting element 42 is moved inward in the radial direction, the respective width of the respective gap S, for example, is thereby reduced. In contrast, if the respective adjusting element 42, for example, is moved relative to damping element 14 and the corresponding structural element or damping element 16 such that the respective adjusting element 42 is also moved outward in the radial direction relative to damping elements 14 and 16, the respective width of the respective gap S, for example, is thereby increased. Thus, the respective width of the respective gap S can be adjusted by means of the aforementioned thread such that the respective width and thus the damping effect can be adjusted especially simply and precisely as well as on a need basis.

With the first embodiment, wall regions 26 and 28 have at least substantially straight or linear contours, by means of which damping chambers 18a-d are limited, particularly in the circumferential direction of the damping apparatus 10. In doing so, the contours of wall regions 26 extend inward toward one another in the radial direction of the damping apparatus 10, wherein the contours of wall regions 28 also extend inward toward one another in the radial direction of the damping apparatus 10.

FIG. 3 shows a second embodiment of the damping apparatus 10. With the second embodiment, precisely two damping chambers 18a, b are provided, wherein the contours of wall region 26, which directly limit damping chambers 18a, b, extend parallel to one another or coincide. In contrast, the contours of wall region 28, which directly limit damping chambers 18a, b, extend at an angle or perpendicular to one another and, in doing so, extend inward toward one another in the radial direction. The contours are also linear with the second embodiment.

In contrast to this, in a third embodiment shown in FIG. 4, it is provided that wall regions 26 and 28 directly limiting respective damping chambers 18a-d or the contours thereof directly limiting damping chambers 18a-d have a bow-shaped profile, which extends over the complete radial extension of respective damping chambers 18a-d.

Finally, FIG. 5 shows a fourth embodiment of the damping apparatus 10. With the fourth embodiment, damping element 14 has a first thread in the form of an inner thread 44, wherein damping element 16 has a second thread in the form of an outer thread 46. In this case, the threads (inner thread 44 and outer thread 46) are screwed together such that the threads interlock. In other words, damping elements 14 and 16 are screwed together via the inner thread 44 and the outer thread 46. The rotating capacity of damping elements 14 and 16 relative to one another about the axis of rotation 12 is indicated by a double arrow 48 in FIG. 5. By means of the threads, relative rotations between damping elements 14 and 16 are converted into a translational relative motion between damping elements 14 and 16.

In other words, if damping elements 14 and 16 are rotated about the axis of rotation 12 relative to one another, this results in translational relative motions of damping elements 14 and 16, in particular along the axis of rotation 12, wherein said translational relative motions between damping elements 14 and 16 are indicated by a double arrow 50 in FIG. 5. For example, if damping element 16 is rotated, in a first direction of rotation, about the axis of rotation 12 relative to damping element 14, damping element 16, for example, is moved translationally toward damping element 14, along the axis of rotation 12. In contrast, if damping element 16 is rotated, in a second direction of rotation opposite the first direction of rotation, about the axis of rotation 12 relative to damping element 14, damping element 16, for example, is thereby moved away from damping element 14, along the axis of rotation 12. If damping element 16 is moved toward damping element 14, damping element 16 is thus moved relative to damping element 14 in a first direction, along the axis of rotation 12. If damping element 16 is moved away from damping element 14, damping element 16 is moved translationally in a second direction opposite the first direction, relative to damping element 14, along the axis of rotation 12.

The damping apparatus 10 according to the fourth embodiment comprises a first damping part 52 retained on damping element 14, with said damping part being formed from an elastically deformable material, particularly from rubber or from an elastomer. In this case, the damping part 52 is arranged on a first end wall 54 of damping element 14, with said end wall facing damping element 16. Furthermore, a second damping part 56, opposite damping part 52, is provided on damping element 14, with the second damping part being arranged, for example, on end wall 58, opposite end wall 54, of damping element 14. In doing so, damping parts 52 and 56 or end walls 54 and 58 are positioned opposite one another along the axis of rotation 12, along which damping elements 14 and 16 can be moved translationally relative to one another in that damping elements 14 and 16 are rotated relative to one another.

If damping element 16 is moved translationally into the first direction relative to damping element 14 in the described manner, damping element 16, particularly an end wall 60, opposite damping part 52, of damping element 16, comes to rest in supportive contact with damping part 52. As a result, damping part 52 is elastically deformed, whereby motion energy, for example, is converted into deformation energy. Contact or edge changes and thus load changes can thereby be damped especially well. In contrast, if damping element 16 is moved translationally into the second direction relative to damping element 14 in the described manner, damping element 16, particularly an end wall 62, opposite damping part 56, of damping element 16, comes to rest in supportive contact with damping part 56. As a result, damping part 56 is elastically deformed, whereby motion energy, in turn, is converted into deformation energy. An especially advantageous contact or edge change damping can thereby be implemented. Through the use of damping parts 52 and 56, which are opposite one another, contact or edge change damping can be implemented, particularly on both sides. It should be particularly noted with such damping on both sides that contact or edge changes can be damped both in the first direction of rotation as well as in the second direction of rotation.

1-14. (canceled)

15. A damping apparatus for a drivetrain of a motor vehicle, comprising:
a first damping element which is rotatable about an axis of rotation;
a second damping element which can be driven by the first damping element and is thereby rotatable about the axis of rotation;
at least two damping chambers, the volumes of which can be modified by a relative rotation between the damping elements;
at least one overflow channel, by means of which the damping chambers are connected to one another fluidly; and
a damping fluid, which flows from one damping chamber into the other damping chamber via the overflow channel upon a volume reduction of one of the damping chambers,
wherein the overflow channel flowing into the respective damping chambers at both ends is formed by a gap between the damping elements, said gap being directly limited by the damping elements, at least in a lengthwise region.

16. The damping apparatus according to claim 15, wherein the overflow channel is formed, at least predominantly, particularly completely, by the gap.

17. The damping apparatus according to claim 15, wherein the width of the gap can be adjusted in order to adjust the damping effect of the damping apparatus.

18. The damping apparatus according to claim 17, wherein at least one adjusting element is provided, which is moveable relative to at least one of the damping elements and directly limits at least one portion of the gap, it being possible to adjust the width of the gap by means of said adjusting element.

19. The damping apparatus according to claim 18, wherein the adjusting element is a component of one of the damping elements.

20. The damping apparatus according to claim 19, wherein the adjusting element is retained in a movable manner on a corresponding structural element of the one damping element, a component of which is the adjusting element.

21. The damping apparatus according to claim 17, wherein the width of the gap can be adjusted by means of at least one thread.

22. The damping apparatus according to claim 20, wherein the adjusting element has the thread and is retained in a movable manner on the structural element via the thread and via a corresponding further thread provided on the structural element.

23. The damping apparatus according to claim 15, wherein the damping elements directly limit the damping chambers.

24. The damping apparatus according to claim 15, wherein at least one wall region limiting at least one of the damping chambers has a bow-shaped profile.

25. The damping apparatus according to claim 24, wherein the bow-shaped profile extends over the entire radial extension of the at least one damping chamber.

26. A damping apparatus for a drivetrain of a motor vehicle, comprising:
a first damping element, which is rotatable about an axis of rotation; and
a second damping element, which can be driven by the first damping element and is thereby rotatable about the axis of rotation, wherein
the damping elements have respective threads screwed together, by means of which a relative rotation between the damping elements can be converted into a translational relative motion between the damping elements, and
at least one damping part, formed from an elastically deformable material, is arranged on at least one of the damping elements, it being possible to move the other respective damping element in supportive contact due to the translational relative motion.

27. The damping apparatus according to claim 26, wherein at least one further damping part, formed from an elastically deformable material and opposite damping part, is arranged on at least one of the damping elements, it being possible to move the other respective damping element in supportive contact due to the translational relative motion.
